(19) United States
(12) Patent Application Publication
(10) Pub. No.: US 2008/0024433 A1
(43) Pub. Date: Jan. 31, 2008

(54) METHOD AND SYSTEM FOR AUTOMATICALLY SWITCHING KEYBOARD/MOUSE BETWEEN COMPUTERS BY USER LINE OF SIGHT

(75) Inventors: Adam Marshal Gunther, Raleigh, NC (US); Hugh Edward Hockett, Raleigh, NC (US); Eric Kirchstein, Raleigh, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/460,243

(22) Filed: Jul. 26, 2006

(51) Int. Cl. G09G 5/00

(52) U.S. Cl. 345/156

(57) ABSTRACT

An invention is disclosed for coupling a computer/display monitor combination with a dedicated sight recognition sensor that is capable of detecting head and/or eye movement from a user. When a sight recognition sensor for a given computer/display monitor combination detects that user sight is being fixed on the monitor, it relays this information to a switch connecting the sensor with its paired monitor and computer. The switch also automatically links a shared keyboard/mouse combination with the computer that is paired to the selected display monitor in view of the user, in order to allow input(s) to be sent from the keyboard and/or mouse to that computer. This link remains active until another sight recognition sensor detects vision being fixed upon a different monitor.

### TECHNICAL FIELD

This invention relates to a method and system for automatically switching a keyboard and/or mouse between computers by detecting user sight.

### BACKGROUND

With the development of new technology permitting use of many different types of multitasking environments with personal computers (PCs), some computer users prefer to work by viewing multiple computer display monitors simultaneously while using a single keyboard/mouse combination for all computers in use. The existing products having such capabilities present certain drawbacks, such as requiring physical movement of the mouse cursor in order to permit switching of the keyboard and mouse input from one computer/monitor combination to another. (See, e.g., [http://www.kavoom.biz/km] incorporated by reference herein.) Ideally, such a switch should occur automatically based on which display monitor the user is viewing at any particular time.

This invention provides such an “automatic switching” capability, by coupling a computer/display monitor combination with a dedicated sight recognition sensor that is capable of detecting head and/or eye movement from a user, in order to automatically link a shared keyboard/mouse combination with the computer that is paired to the selected display monitor in view of the user, so as to allow input(s) to be sent from the keyboard and/or mouse to that computer.

### SUMMARY OF THE INVENTION

This invention provides a method and system for automatically switching a keyboard and/or mouse between independent or networked computers by detecting user sight. Specifically, an invention is disclosed for coupling a computer/display monitor combination with a sight recognition sensor (either built-in or installed separately) that is capable of detecting head and/or eye movement from a user. When a sight recognition sensor for a given computer/display monitor combination detects that user sight is being fixed on the monitor, it relays this information to a switch (such as a keyboard/video/mouse (KVM) switch) connecting the sensor with its paired monitor and computer. The switch also automatically links a shared keyboard/mouse combination with the computer that is paired to the selected display monitor in view of the user, in order to allow input(s) to be sent from the keyboard and/or mouse to that computer. This link remains active until another sight recognition sensor detects vision being fixed upon a different monitor.

It is therefore an object of the present invention to overcome the disadvantages of the prior art by providing a method and system for automatically switching a keyboard and/or mouse between computers by detecting user sight.

It is another object of the present invention to overcome the disadvantages of the prior art by providing a computer system or network which couples each computer/display monitor combinations with a sight recognition sensor that is capable of detecting head and/or eye movement from a user, so that when a sight recognition sensor for a given computer/display monitor combination detects that user sight is being fixed on the monitor, it relays this information to a switch connecting the sensor with its paired monitor and computer, such that the switch automatically links a shared keyboard/mouse combination with the computer that is paired to the selected display monitor in view of the user, in order to allow input(s) to be sent from the keyboard and/or mouse to that computer.

It is another object of the present invention to overcome the disadvantages of the prior art by providing a method and system for automatically switching a keyboard and/or mouse between computers by detecting user sight, wherein the link between the shared keyboard/mouse combination and the computer that is paired to the selected display monitor in view of the user remains active until another sight recognition sensor detects vision being fixed upon a different monitor.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 is a diagram illustrating use of a computer/display monitor combination with a sight recognition sensor that is capable of detecting head and/or eye movement from a user.

### DETAILED DESCRIPTION OF THE PREFERRED EMBODIMENTS

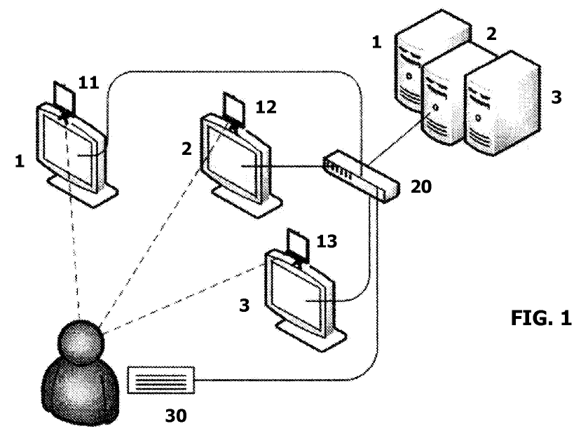

FIG. 1 is a diagram illustrating use of an independent or networked computer/display monitor combination 1 or 2 or 3 coupled with a dedicated sight recognition sensor 11 or 12 or 13 respectively, that is capable of detecting head and/or eye movement from a user, in order to automatically link a shared keyboard/mouse combination 30 with the computer that is paired to the selected display monitor in view of the user, so as to allow input(s) to be sent from the keyboard and/or mouse to that computer. An accelerometer and/or a focused infrared (IR) detector with a signal sensor located on the computer display monitor can be used as a sight recognition device for this purpose; as can face recognition technology using digital and/or video cameras, such as that used in the “Head-Tracking Pointer” device described on the IBM alphaWorkswebsite [http://www.alphaworks.ibm.com/tech/headpointer]; as can methods described in U.S. Pat. No. 6,734,845 and in [http://www.worldscibooks.com/engineering/etextbook/4652/4652-intro4.pdf] (the teachings of all of which are incorporated by reference as if fully set forth herein); as can other types of sensors that are capable of detecting head and/or eye movement from a user. The invention can be implemented through installation of such external hardware; however, such user sight recognition devices can also be incorporated directly into the design of the computer display monitor itself.

Communication between a user sight recognition device and a computer/display monitor can be implemented by using at least one switch 20 (such as a mechanical or electronic keyboard/video/mouse (KVM) switch) to connect each computer/display monitor combination 1 or 2 or 3 with its associated sight recognition sensor 11 or 12 or 13 respectively. This communication between the user sight recognition device and the “line of sight” switch allows the selected computer/display monitor combination 1 or 2 or 3 (respectively associated with the viewed sensor 11 or 12 or 13) to link to the shared keyboard/mouse 30 via a connection established through switch(es) 20. Communication between the shared keyboard/mouse peripherals and the switch(es) can be implemented in a hardwired connection (as is done with common KVM devices) or by use of wireless technology (e.g., a Bluetooth®-type device). Communication between the switch(es) and the computer/display monitor(s) can also be implemented by use of a hardwired (or wireless) connection linking each computer/display monitor combination to a switch. As described above, the switch handles the link from the selected computer/display monitor combination to the shared keyboard/mouse.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer system or network for automatically switching a shared keyboard or mouse between computers by detecting user sight and comprised of at least the following components:
(a). two or more computer and display monitor combinations each coupled with a sight recognition sensor that detects head or eye movement from a user;
(b). at least one switch connecting the sensor with its paired monitor and computer for linking the keyboard or mouse with the computer that is paired to the selected display monitor in view of the user so that inputs are sent from the keyboard or mouse to that computer;
wherein a sensor coupled to a computer and display monitor relays a signal to its switch when the sensor detects that user sight is being fixed on its monitor so that the switch automatically links the keyboard or mouse with the computer that is paired to the viewed display monitor.

2. The computer system or network of claim 1 wherein the link between the keyboard or mouse and the computer that is paired to the viewed display monitor remains active until another sensor detects vision being fixed upon a different monitor.

3. The computer system or network of claim 1 wherein the link between at least two connected components is established by use of a hardwired connection.

4. The computer system or network of claim 1 wherein the link between at least two connected components is established by use of a wireless connection.

5. The computer system or network of claim 1 wherein at least two computers operate independent of each other.

6. The computer system or network of claim 1 wherein at least two computers operate in a network.

7. The computer system or network of claim 1 wherein at least one sensor is externally installed.

8. The computer system or network of claim 1 wherein at least one sensor is incorporated into the computer display monitor.

9. The computer system or network of claim 1 wherein at least one sensor is selected from a group consisting of an accelerometer or an infrared detector or a digital or video camera.

10. The computer system or network of claim 1 wherein at least one switch is selected from a group consisting of a mechanical or electronic switch.

11. A method of using a computer system or network for automatically switching a shared keyboard or mouse between computers by detecting user sight and comprised of at least the following components for performing a procedure comprised of the following steps:
(a). coupling each of two or more computer and display monitor combinations with a sight recognition sensor that detects head or eye movement from a user;
(b). operating at least one switch to connect the sensor with its paired monitor and computer so as to link the keyboard or mouse with the computer that is paired to the selected display monitor in view of the user so that inputs are sent from the keyboard or mouse to that computer;
wherein a sensor coupled to a computer and display monitor relays a signal to its switch when the sensor detects that user sight is being fixed on its monitor so that the switch automatically links the keyboard or mouse with the computer that is paired to the viewed display monitor.

12. The method of claim 11 wherein the link between the keyboard or mouse and the computer that is paired to the viewed display monitor remains active until another sensor detects vision being fixed upon a different monitor.

13. The method of claim 11 wherein the link between at least two connected components is established by use of a hardwired connection.

14. The method of claim 11 wherein the link between at least two connected components is established by use of a wireless connection.

15. The method of claim 11 wherein at least two computers operate independent of each other.

16. The method of claim 11 wherein at least two computers operate in a network.

17. The method of claim 11 wherein at least one sensor is externally installed.

18. The method of claim 11 wherein at least one sensor is incorporated into the computer display monitor.

19. The method of claim 11 wherein at least one sensor is selected from a group consisting of an accelerometer or an infrared detector or a digital or video camera.

20. The method of claim 11 wherein at least one switch is selected from a group consisting of a mechanical or electronic switch.
